(19) United States
(12) Patent Application Publication
(10) Pub. No.: US 2023/0214920 A1
(43) Pub. Date: Jul. 6, 2023

(54) METHOD OF SUPPLYING LOANED FUNDS TO EMPLOYEES FOR INCREASED PARTICIPATION IN BROAD-BASED EMPLOYEE STOCK OWNERSHIP PLANS

(71) Applicant: THOMAS HECHT, WILBRAHAM, MA (US)

(72) Inventor: THOMAS HECHT, WILBRAHAM, MA (US)

(21) Appl. No.: 18/119,507

(22) Filed: Mar. 9, 2023

Related U.S. Application Data
(63) Continuation-in-part of application No. 14/613,535, filed on Feb. 4, 2015.

(51) Int. Cl. G06Q 40/03; G06Q 40/06

(52) U.S. Cl. CPC G06Q 40/03; G06Q 40/06

(57) ABSTRACT

The present invention relates to a system and method of supplying and repaying loaned funds provided to an employee participating in a contribution based broad-based employee stock ownership plan, or in an employer-provided retirement plan. In particular, the present invention relates to a method and system for enabling an employee to contribute more funds into his/her broad-based employee stock ownership plan, or in an employer-provided retirement plan by offering a line of credit up to the vested contribution and benefit amount for the employee to originate against.

### CLAIM OF PRIORITY

This application claims priority to U.S. patent application Ser. No. 14/613,535 which was filed on Feb. 4, 2015.

### FIELD OF THE INVENTION

The present invention relates to a method of supplying and repaying loaned funds from a line of credit automatically provided to an employee participating in a contribution based broad-based employee stock ownership plan, or in an employer-provided retirement plan. In particular, the present invention relates to a method for enabling an employee to contribute more funds into an employee sponsored defined benefits plan like a 401(k), 403(b) or some similar other kind of defined benefits plan at his/her discretion and timing using a line of credit.

### BACKGROUND OF THE INVENTION

An employee stock ownership plan (ESOP) is an employee benefit plan that gives workers ownership interest in the company in the form of shares of stock. ESOPs give the sponsoring company, i.e., the selling shareholder, and participants various tax benefits, making them qualified plans, and are often used by employers as a corporate finance strategy to align the interests of their employees with those of their shareholders.

The purpose of a broad-based employee defined benefits plan, such as an Employee Stock Purchase Plan (ESPP), is to encourage broad-based employee ownership of employer stock. Through a broad-based employee stock ownership plan that qualifies under Sections 421 and 423 of the Internal Revenue Code (the “Code”), an employee subject to U.S. tax law can purchase stock at a discount from fair market value and if certain holding period requirements are met, receive preferred tax treatment upon sale of the broad-based employee stock ownership plan shares.

Certain benefits of a broad-based employee defined benefits plan accrue to the employer as well. For example, the employer incurs no compensation expense for financial accounting purposes with respect to grants made under a broad-based defined benefits plan like an employee stock ownership plan, also often referred to as an employee stock option plan.

One general feature of an exemplary employee stock option plan herein is the possible availability of employer “discount off the purchase price” plans, wherein a percentage of the stock price is “discounted” by an employer.

For example, with a broad-based employee stock ownership plan, employee contributions can range from one percent (1%) to twenty-five percent (25%) and/or up to an allowable maximum, with a five percent (5%) to fifteen (15%) employer discount of the employer stock price. The employee is offered the discount on the closing price of the day of purchase. In practice, contributions are withheld from an employee's paycheck and held in an escrow account which is generally interest bearing for a holding period (generally X+1 year), at which time they are converted to stock if the price is above the discounted price.

Generally speaking, such discounting plans offer employees additional “risk-free” and “free” funds from their employer if the employee is able to contribute to the plan, as the principal plus interest is reimbursed to the employee if the stock price falls below the discounted price at the end of the holding period. Further, an employee will only obtain the most benefit of these “risk free funds” by contributing the highest percentage of his/her salary that is eligible up to the plan maximum and/or future IRS laws or other regulatory laws.

A broad-based defined benefit plan that includes an employee stock ownership plan according to the present disclosure may be, without limitation, be a stock option/purchase plan (ESOP/ESPP), Employee Stock Ownership Plan, Stock Option Grants, Individual Equity Plans, or Employee Stock Purchase Plans. More specifically, an ESOP/ESPP may be an IRS U.S. Code § 423 qualified or IRS U.S. Code § 423 non-qualified plan. Even more specifically, the ESOP/ESPP may be a plan substantially similar to an IRS U.S. Code § 423 qualified, or non-qualified, Employee Stock Purchase plan.

A large opportunity exists within the framework of Employee Stock Option Plans particularly, or indeed other types of broad-based employee stock ownership plans, to allow for change and improvement in an employee's ability to acquire more and therefore save more.

The importance of employee participation in these broad based employee stock ownership plans cannot be overstated and is critical to both employee and employer retirement and company valuation success. Similarly, employees benefit from maximal contribution to an employer retirement plan. The importance of saving enough for retirement cannot be overemphasized and it is essential that all employees participate in a broad-based employee stock ownership plan when possible and use it fully.

As of 2014, the National Center for Employee Ownership (NCEO) estimates that there are roughly seven thousand employee stock ownership plans (ESOPs) covering about 13.5 million employees. As has been widely recorded, participants in ESOPs most often do well financially. A 1997 Washington State study found that ESOP participants made five percent (5%) to twelve percent (12%) more in wages and had almost three times the retirement assets as did workers in comparable non-ESOP companies. As many as 11 million employees buy shares in their employer through employee stock purchase plans.

According to a 2010 NCEO analysis of ESOP company government filings in 2008, the average ESOP participant receives about $4,443 per year in company contributions to the ESOP and has an account balance of $55,836. People in the plan for many years would have much larger balances given typical company contributions.

ESOPs can be found in all kinds of sizes of companies. Some of the more notable majority employee-owned companies are Publix Super Markets (160,000 employees), Lifetouch (25,000 employees), W. L. Gore and Associates (maker of Gore-Tex, 10,000 employees), and Davey Tree Expert (7,800 employees). Companies with ESOPs and other broad-based employee ownership plans account for well over half of Fortune Magazine's “100 Best Companies to Work for in America” list year after year.

Further, it has been definitively shown that companies that combine employee ownership with employee workplace participation programs show even more substantial gains in performance. A 1986 NCEO study found that employee ownership firms that practice participative management grow eight percent (8%) to (11%) per year faster with their ownership plans than they would have without them.

Sadly, as evidenced by the above, many employees are unable to contribute the funds necessary to realize the optimal amount of employer-contributed discount stock prices or accomplish the maximal benefit of an employer retirement plan available to them. In times of economic hardship, employees simply cannot afford to make the contribution from their salary pay period, essentially forfeiting “risk free funds” otherwise available to them from their employer, or otherwise understandably putting today's needs ahead of planning for tomorrow.

As a result, a need exists for a system and method of extending financial assistance to employees with access to stock discounting plans, or retirement plans, by employers. For a broad-based employee stock ownership plan, these systems and/or method should enable employees to secure the maximum discount of the purchase price available to them without the increased financial burden associated with providing a maximum contribution to these “risk free funds”. For an employer retirement plan, it would allow employees to contribute maximally to the plan without having to use their own funds.

### BRIEF SUMMARY OF THE INVENTION

Accordingly, the invention provides a method within a computerized system that maximizes an employee's defined benefit plan contribution. The method comprises providing an employer provided defined benefit plan for employee use through an employer's electronic computerized system. Also provided is an employee defined benefit account within the employer's defined benefit plan through the employer's electronic computerized system.

The computerized system that operates and maintains the employer's defined benefit stock purchase program operates by execution of one or more algorithms which evaluates and chooses an optimal time of discount security purchases and amount of additional funds needed to maximize the discount security purchases.

The employer's computerized system has at least one central processing unit, non-transitory memory in operational connection with the central processing unit, one or more algorithms (computer programs) written onto the non-transitory memory and having instructions for operation of the central processing unit.

In practice, the employer's computerized system operates to connect an employee's contribution to the defined benefit account to the employer's computerized system. It also calculates the difference between the employee's contribution to the defined benefit account and the maximum allowed contribution to the defined benefit account through the algorithm. Further, the employer's computerized system provides an electronic line of credit for additional stock purchase usable by the employee on an ad hoc basis to maximize the employee's defined benefit account. The electronic line of credit is storable in an electronic ledger on the computerized system. The electronic ledger is accessible to the employee for securities purchases into his/her defined benefit plan.

With the now available funds from the electronic line of credit, employees may purchase, on an ad hoc basis or pre-calculated basis, a maximum number of discounted stock shares (or other securities) from proceeds thereof and thereafter electronically depositing the purchased discounted securities into the employee's defined benefit account.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 is a flowchart of the preferred embodiment herein performed by and through a computerized system for tracking, speed and accuracy;

FIG. 2 is a block diagram of one embodiment of the present invention;

FIG. 3 is a transactional flowchart of an exemplary embodiment of the present invention including an Employee Stock Option Plan; and

FIG. 4 is a flowchart of example calculations associated with a hypothetical employee utilizing the methodology of FIGS. 1 and 2.

### DETAILED DESCRIPTION OF THE INVENTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the application (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

“Defined Contribution Benefit Plans” have become a dominant employee retirement benefit platform often either supplementing or completely replacing “Defined Benefit Retirement Plans” offered by employers. Generally, these types of plans are regulated under the Employee Retirement Income Security Act (“ERISA”) with, for example, possible restrictions on retirement fund access prior to retirement age or other special circumstances. Examples of Defined Contribution Benefit Plans include 401(k) plans, 403(b) plans, employee stock ownership plans, simplified employee pension plans (SEPs) and profit-sharing sharing plans. Of particular interest, 401(k) plans are a widely known retirement platform today.

One general feature of Defined Contribution Benefit Plans is the possible availability of employer “matching fund” plans, wherein a percentage of employee pre-tax or after-tax contributions are “matched” by an employer. For example, with a 401(k) plan, employee contributions range from one percent (1%)—seven percent (7%), with either a fifty percent (50%) or one-hundred (100%) employer match of the employee contribution.

Generally speaking, such matching plans offer employees additional “free” contribution funds from their employer if the employee is able to contribute to the plan. Further, the employee will only obtain the most benefit of these “free funds” by contributing the highest percentage of his/her salary that is eligible under both a particular employer's “matching fund” plan and current and/or future ERISA laws or other regulatory laws.

By the term employee retirement plan (i.e., ERP) it is meant herein a pension plan which is an employee benefit plan established or maintained by an employer or by an employee organization (e.g., a union), or both, that provides retirement income or defers income until termination of covered employment or beyond.

The term “retirement plan” may generally be described as including “Defined Contribution Benefit Plans” with the Employee or his/her assignees, etc., as beneficiaries of the plan. These plans include, but are not limited to, 401(k) plans, 403(b) plans, employee stock ownership plans, Simple Individual Retirement Accounts (“Simple IRAs”), simplified employee pension plans (SEPs) and profit sharing plans, among others.

The term “transaction” includes a variety of fund transfers possible to parties involved with defined contribution benefit plans. Additionally, the components/transactions of the present invention can be implemented in hardware via a microprocessor, programmable logic, or state machine, in firmware, or in software with a given device. In one aspect, at least a portion of the software programming is web-based and written in HTML and JAVA programming languages, including links to user interfaces for data collection, such as a Windows based operating system, and each of the main components may communicate via a network using a communication bus protocol.

For example, the present invention may or may not use a TCP/IP protocol suite for data transport. Other programming languages and communication bus protocols suitable for use with the present invention will become apparent to those skilled in the art after reading the present application. Components of the present invention may also reside in software on one or more computer-readable mediums. The term “computer-readable medium” as used herein is defined to include any kind of memory, volatile or non-volatile, such as floppy disks, hard disks, CD-ROMs, flash memory, read-only memory (ROM), and random excess memory (RAM).

By the term employee stock purchase plan (i.e., ESPP) it is meant herein as a qualified 423 employee stock purchase plan allows employees under U.S. tax law to purchase stock at a discount from fair market value without any taxes owed on the discount at the time of purchase.

By the terms “ad hoc” or “ad hoc loans” it is meant herein “created or done for a particular purpose as necessary” and in this instance, loans created or done for a particular purpose as necessary, i.e., company stock purchase investment.

By the term 401(k) plan it is meant herein a defined contribution plan where an employee can make contributions from his or her paycheck either before or after-tax, depending on the options offered in the plan The contributions go into a 401(k) account, with the employee often choosing the investments based on options provided under the plan.

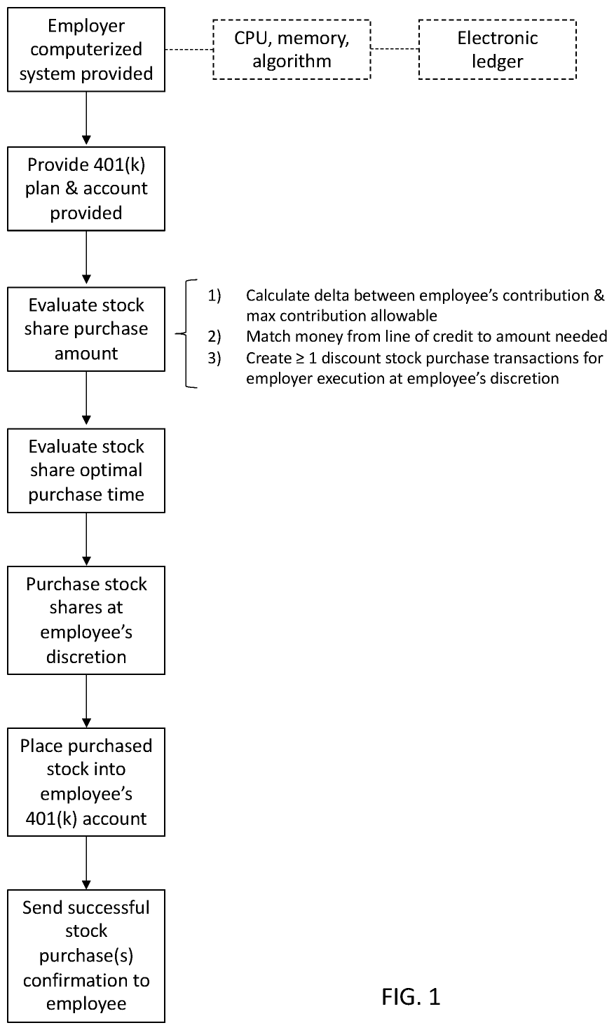

FIG. 1 is a flowchart of the preferred embodiment herein performed by and through a computerized system for tracking, speed and accuracy. To be clear, the best and fastest way to implement the method herein is through a computerized system which checks for accuracy, limits human error and enables wide, trackable distribution across hundreds, thousands or hundreds of thousands of employees.

As shown, an employer computerized system is provided to each employee thereof. The system is accessible to each employee to employer provided devices, e.g., laptop computers, desktop computers, pad devices, company cellphones and the like. The computerized system is shown comprising a central processing unit (CPU), memory, one or more algorithms for operation thereof and an electronic ledger (actually, many thereof) for each employee who participates in an electronically provided defined benefits plan.

Next, the stock share purchase amount is evaluated. Such evaluation includes the following three steps: 1) calculate the delta between an employee's defined benefit plan contribution and the maximum allowable contribution; 2) select the match money amount from the employer provided line of credit to close the delta; and 3) create one or more discount stock purchase transactions for employer execution at the employee's discretion.

Optionally, the optimal best time for an employee to make additional securities purchases into their employer provided defined benefit plan can be calculated through the computerized system. In some instances, it may be more advantageous for an employee to purchase securities (i.e., discounted company stock) than at other times. The discounts and amounts provided may be larger and/or deeper at certain times of the year than at others. An employee herein may therefore maximize their discounts and amount of purchasable employer stock.

Next, when ready, an employee may, using additional funds provided by their employer, purchase securities which are then added to an employee's electronic ledger and which may be later added to an employee's defined benefit plan or remain on the ledger. Once purchased, an electronic confirmation of such purchase is sent to the employee and logged within the computerized system itself.

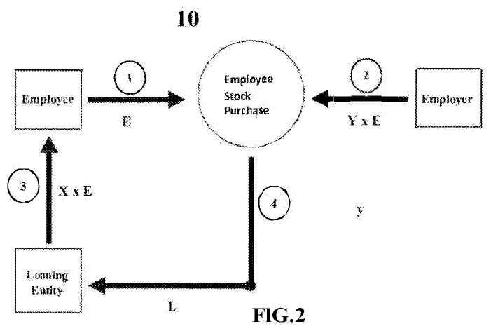

FIG. 2 illustrates some of the embodiments of the present disclosure. In this embodiment, the Employee Stock Purchase Plan (i.e., ESPP) contribution system and method of the present invention may be generally described as providing a system 10 for performing transactions between an employee employed by an employer that otherwise offers participation in a contribution-based ESPP and an appropriate loaning entity such as a bank.

With this in mind, system 10 is adapted to facilitate four transactions: 1) An employee contribution transaction into the ESPP; 2) an employer stock price-subsidizing transaction into the ESPP; 3) an employee contingent fee/interest loan origination transaction from the loaning entity to the employee; and 4) loaning entity reimbursement transaction from the ESPP. As will be described in greater detail below, these four transactions allow the employee to consistently receive maximum matching contributions by the employer into the employee's ESPP by reimbursing the employee with loaned funds from the loaning entity.

In some cases, a holding period will be required for the purchased stock in order to receive favorable long-term capital gains tax treatment on a portion of the gains when the shares are sold. A non-qualified employee stock purchase plan usually works like and is structured like qualified 423 plan, but without the preferred tax treatment for employees. These plans include, but are not limited to, employee stock purchase plans, employee stock ownership plans, employee stock purchase deposit plans, and profit sharing plans, among others.

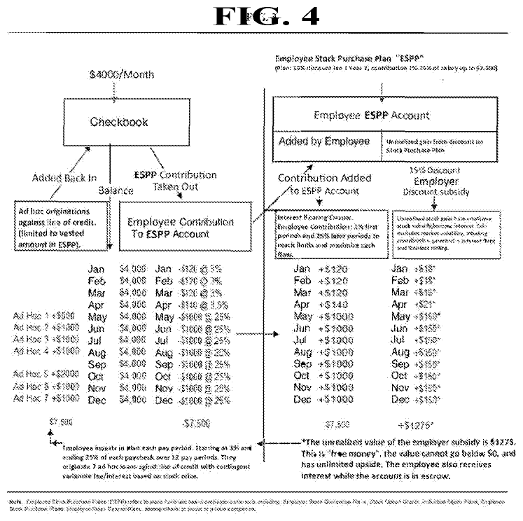

In another embodiment herein, FIG. 4 illustrates a system 20 for performing transactions between an employee and a loaning entity for the purpose of increasing participation and contribution to employer-offered retirement plans; e.g., 401k plans. Similar to system 10, system 20 is adapted to facilitate four transactions: 1) an employee contribution transaction into the employee retirement plan; 2) an employer matching contribution into the employee retirement plan; 3) an employee loan origination transaction from the loaning entity to the employee; and 4) loaning entity reimbursement transaction from the employee retirement plan.

These four transactions enable an employee to consistently receive maximum matching contributions by the employer into the employee's retirement plan by reimbursing the employee with loaned funds from the loaning entity. The term “transaction” herein includes a variety of fund transfers possible to parties involved with any of the systems and methods disclosed herein. Additionally, the components/transactions of the present invention can be implemented in hardware via a microprocessor, programmable logic, or state machine, in firmware, or in software with a given device.

In one aspect, at least a portion of the software programming is web-based and written in HTML and JAVA programming languages, including links to user interfaces for data collection, such as a WINDOWS® based operating system, and each of the main components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may also reside in software on one or more computer-readable mediums. The term “computer-readable medium” as used herein is defined to include any kind of memory, volatile or non-volatile, such as floppy disks, hard disks, CD-ROMs, flash memory, read-only memory (ROM), and random excess memory (RAM).

With reference to the figures herein, the employee contribution transaction I includes a deposit of employee funds E into the employee stock purchase plan of a defined contribution benefit plan. In a preferred embodiment the employee funds E represent after-tax dollars deducted from the periodic paycheck paid to the employee from the employer. In another embodiment, the employee funds E are deducted from the paycheck of the employee prior to taxation. The periodicity of the paycheck and corresponding deduction may vary, but one embodiment of the present invention corresponds to a monthly pay period, which in tum, corresponds to a monthly paycheck deduction transferred into the employee stock purchase plan. The size of the deduction may vary according to the particular employee stock purchase plan and applicable regulatory law. In one preferred embodiment, the employee contribution transaction 1 would be recognized by one of ordinary skill in the art to include a post-tax employee deposit into an ESPP. employee stock purchase

The employer stock price-subsidizing transaction, i.e., the second transaction, into the ESPP includes the employer matching the employee contributed funds E with additional funds representing a discounting percentage Y of the employee contributed funds E into the ESPP. The discounting percentage Y is a function of the particular ESPP and the employer's implementation thereof. For example, in one embodiment, the discounting percentage Y is 15%.

In this example, 3/20 the amount of the employee contributed funds E will be contributed to the Employee Stock Purchase Plan (3/20E=Y×E+E where Y=15%) upon each employee contribution transaction, i.e., the first transaction. It is to be noted that a variety of discounting percentages Y are included within the scope of the present invention, for example 10%. Further, in one preferred embodiment, the employer matching contribution transaction 2 can be a discounting percentage Y associated with a post-tax employee deposited into the ESPP.

The employee contingent fee/interest loan origination transaction, i.e., the third transaction, from the loaning entity to the employee includes the loaning entity transferring supplemental funds up to a percentage X of the Employee contributed funds E to the employee. In a preferred embodiment, the supplement percentage X is 100% of the employee contributed funds E, with the employee contingent fee/interest loan origination transaction occurring at a frequency at the discretion of the employee. With the embodiment of FIG. 1, the loaning entity reimbursement transaction from the employee stock purchase plan can be described to include a dispersal of reimbursement funds L from the employee stock purchase plan to the loaning entity. In one preferred embodiment, the reimbursement funds L are of an amount equal to the employee contribution funds E. Additionally, the loaning entity reimbursement transaction can have the same periodicity as the employee contribution transaction 1 or the employee contingent fee/interest loan origination transaction 3.

Alternatively, the loaning entity reimbursement transaction can occur on a differing schedule, such as a yearly basis. In one embodiment in which the loaning entity reimbursement transaction occurs annually, the employee contribution transaction occurs monthly, and the reimbursement funds L are equal to the employee contribution funds E. In another embodiment, the transaction includes the use of an automated (e-Based) loan type paperless transaction package made available to all U.S. employees where a large financial institution loans employees funds to allow them to secure the additional broad-based employee stock ownership plan discount offered them by the employers in return for a contingent fee/variable interest rate calculated based on the value of the stock with repayment of the loan as a product of any gains being split. Additionally, when the actual stock price nears the discounted price near the term date, the loaning entity, L is then able to withdraw the principal balance and pay accumulated interest to the employee.

The system shown in FIG. 1 includes a deposit of employee funds E into the employee retirement plan. In a preferred embodiment the employee funds E represent funds E which are deducted from the paycheck of the employee prior to taxation. The periodicity of the paycheck and corresponding deduction may vary, but one embodiment of the present invention corresponds to a monthly pay period, which in tum, corresponds to a monthly paycheck deduction transferred into the ESPP. The size of the deduction may vary according to the particular employee retirement plan and applicable regulatory law. In one preferred embodiment, the employee contribution transaction 1 would be recognized by one of ordinary skill in the art to include a post-tax employee deposit into an employee retirement plan, with a remainder of the paycheck being dispersed to the employee or elsewhere.

The employer matching contribution transaction 21 into the ERP includes the employer matching the employee contributed funds E with additional funds representing a certain matching percentage Y of the Employee contributed funds E into the ESPP. The particular percentage Y is a function of the particular ERP and the employer's implementation thereof. For example, in one embodiment, the matching percentage Y is 15%. With this one example, 3/20 the amount of the employee contributed funds E will be contributed to the ERP (3/20E=Y×E+E where Y=15%) upon each employee contribution transaction 1. It is to be noted that a variety of discounting percentages Y are included within the scope of the present invention, for example 10%. Further, in one preferred embodiment, the employer matching contribution transaction 2 can be a discounting percentage Y associated with a post-tax employee deposited into the ERP.

In some embodiments, the loan origination transaction from the loaning entity to the employee does not include interest or fees. In some embodiments, the loan origination transaction from the loaning entity to the employee does not include interest but does include fees as determined by the loaning entity. In yet other embodiments, the loan origination transaction from the loaning entity to the employee includes interest and/or fee/s as determined by the loaning entity. In some embodiments, the employee contingent fee/interest loan origination transaction from the loaning entity to the employee includes the loaning entity transferring supplemental funds up to a percentage X of the employee contributed funds E to the employee. In a preferred embodiment, the supplement percentage X is 100% of the employee contributed funds E, with the employee contingent fee/interest loan origination transaction occurring at a frequency at the discretion of the employee.

In the embodiment of FIG. 4, the loaning entity reimbursement transaction from the employee retirement plan can be described to include a dispersal of reimbursement funds L from the ERP to the loaning entity. However, in some other embodiments instead of withdrawing ERP and incurring a penalty, presently described method provides for other routes for returning the borrowed funds. For example, a borrower may use loans, or pairing with the borrower's ESPP, or even pooling with other borrowers in order to optimize the collective outcome. In one preferred embodiment, the reimbursement funds L are of an amount equal to the employee contribution funds E. Additionally, the loaning entity reimbursement transaction can have the same periodicity as the employee contribution transaction or the employee contingent fee/interest loan origination transaction.

Alternatively, the loaning entity reimbursement transaction can occur on a differing schedule, such as a yearly basis. In one embodiment in which the loaning entity reimbursement transaction occurs annually, the employee contribution transaction occurs monthly, and the reimbursement funds L are equal to the employee contribution funds E. In another embodiment, the transaction includes the use of an automated (e-Based) loan type paperless transaction package made available to all U.S. employees where a large financial institution loans employees funds to allow them to secure the additional retirement plan matching contribution offered them by the employers in return for a contingent fee/variable interest rate calculated based on the value of the loan.

It is expressly contemplated herein that the borrower/employee has the flexibility to make contributions to their 401(k) (or any other retirement plan), according to their financial ability. For example, a borrower/employee may contribute any amount in the range of zero to ninety-nine percent of the allowable contribution to their 401(k). In some embodiments, the employee/borrower then can the loaning entity contribute the remaining funds up to the maximum allowable. In some other embodiments, the employee/borrower can determine that the loaning entity will contribute funds up to a certain percentage of the maximum allowable.

The present disclosure provides several options with regards to the return of loaned funds, from the employee/borrower to the loaning entity. For those employee/borrower who reached the age of fifty-nine and one-half (59.5) years, there is the option of using funds withdrawn, penalty free, from their 401(k). In some other embodiments, the employee takes a loan from their 401(k) and then pay the loan and interest back to themselves. Depending on the plan, up to 50% of the 401(k) balance may be taken as a loan. In some embodiments, an employee may be able to secure a deferred-payment loan from their 401(k) in order to return the loaning entity loan (e.g., the loan from the 401(k) may not be paid back for 20 years).

In some embodiments herein, an employee uses a combination of at least two of the options mention herein to secure funds for returning the loan to the loaning entity. As a one unlimiting example, an employee may take a loan from their 401(k) to pay the loaning entity loan, and then pays the loan back to their 401(k) through payroll withdrawals. The presently disclosed system and method allows for a flexible return of loaned funds via the employee paycheck to match their financial circumstances.

The line of credit provided by a loaning entity herein, as depicted in at least FIGS. 1 and 4 allows a borrower (e.g., the employee) to regulate/control the amount and timing of sums borrowed, providing flexibility. For example, an employee can decide to borrow a certain fixed amount monthly or decide to only borrow certain amounts as needed and when needed. As another example, an employee may decide to borrow at the end of the plan year versus a fixed amount regularly.

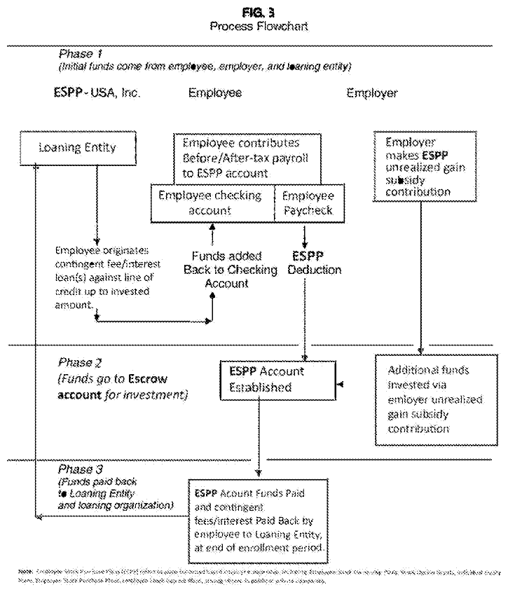

Exemplary Embodiments of FIGS. 2 and 3 Including an Employee Stock Purchase Plan Contribution Method and System. The method of the present invention can be described with reference to the exemplary flowchart of FIG. 2 that otherwise relates to an ESPP in conjunction with the flowchart of FIG. 3 that provides specific dollar amounts for a hypothetical employee using the system and method of FIGS. 1 and 2 as part of the embodiment of an ESPP. In general terms, and as illustrated in FIG. 2, at Step or Phase 1, the employee contributes to his/her ESPP account via a payroll deduction (i.e., employee contribution transaction); the employer makes an unrealized subsidy matching payment to the employee's ESPP account (i.e., employer contribution-matching transaction); and the loaning entity automatically generates a line of credit for (or loans) a percentage of the employee contribution to the employee (i.e., employee contingent fee/interest loan origination transaction). At Step or Phase 2, the ESPP account is managed in accordance with pre-defined parameters. At Step or Phase 3, the loaning entity automatically receives a payment or reimbursement from the ESPP account in payment of amounts loaned to the employee plus applicable interest and fees (i.e., loaning entity reimbursement transaction).

With the example of FIG. 3, 3% Periods 1-4, 3.5% Period 4, and 25% periods 5-12, totaling $7,500 is deducted from the employee's paycheck each month as the employee contribution transaction. In one embodiment, the employee contribution funds are invested into an interest bearing ESPP escrow account and accumulated for twelve consecutive months with increasing contribution percentages. In this manner, there is reduced risk to this money as it the bulk of the investment is made towards the end of the term, although it's invested in guaranteed funds (money market funds, for example), the underlying risk of the company can be better assessed over time. With continued reference to the examples of FIG. 3, the loaning entity is a “line of credit loan” financial backer along with a large-scale financial institution.

In this exemplary embodiment, the loaning entity can make ad hoc loans to the employee's checking account equal to 100% of the accumulate contribution deducted. Preferably, this amount provides sufficient coverage such that the employee sees little difference in his/her checkbook balance during the process of removing and replacing funds to enable the funding of his/her ESPP account. Employees thus have sufficient funds to meet periodic expenses while securing their employer's ESPP discounting funds. With the hypothetical of FIG. 3, the employee has accumulated unrealized gain of $1275 of discounted money by year's end. Gains vary based on stock performance; however, typically the principal balance plus accumulated interest is the floor.

With reference to FIGS. 2 and 3, the loan transaction (or employee contingent fee/interest loan origination transaction) follows has a contingent gain rule. Thus, a typical contingent X% interest and $X fee/commission is charged to employees to gain a 100% loan of funds used to secure the matching funds from their employer. Alternatively, other percentages can be utilized. In one embodiment, a loan transaction may be described with reference to an employee having a one to twenty-five percent (1-25%) post-tax/post-tax ESPP matching plan where the employer matches 15% of the employee contribution with an unrealized gain on the discounted stock price. In a related embodiment, the employee is paid on a monthly basis and the employee chooses a post-tax ESPP plan.

The loan transaction can include the employee signing up for the ESPP discounting program at a twenty-five (25%) match with the twenty-five percent (25% post-tax) funds withdrawn from the monthly paycheck of the employee and put into a ESPP account with the fifteen percent (15%) match made by the employer. Additionally, a preferred embodiment includes the loaning entity backing the employee with up to one-hundred percent (100%) of the twenty-five (25%) accumulated withdrawals from his paycheck, which is deposited back into his payroll savings account electronically the at the employee's discretion. In doing this electronic transaction, the employee hardly sees a difference in the checking account of the employee, yet gains the full “free” money, or contribution matching funds, paid by the employer in making the match.

With reference to FIGS. 2 and 3, a preferred embodiment of the loan payback transaction (or the loaning entity reimbursement transaction) includes the employee signing a contract with the loaning entity to pack back funds loaned them at year-end. In one example, the employee pays an X% fee to get a one hundred percent (100%) match on ESPP Funds if the stock price is greater than the exercise price at the end of the term. Thus, employees can build up employee stock purchase funds to full advantage without jeopardizing their own funds on a paycheck-to-paycheck basis. As a normative proposition, many people need all their paycheck dollars to afford planned and unplanned emergencies. This is a possible explanation as to why people offered ESPP programs do not take advantage of them. For the purpose of the present disclosure, the loaning entity may be, for example, a business cooperative comprised of employees with like plans, institutional investors, and/or a pool of individual investors. In some embodiments, the loaning entity is the employer.

With regards to the embodiments disclosed herein which relate to retirement plans, the employer, in the capacity of a loaning entity, may directly contribute into an employee 401(k) as a sole contributor (e.g., by providing the employee with loaned funds to be invested in her/his retirement plan), have a match component in addition to an employee contribution, or have matching component and also provide the employee with loaned funds to be invested in her/his retirement plan. In some embodiments, the employer may supplement, for example, by loaning the employee funds, the employee contribution up to the maximum allowable.

In some embodiments, the employer contribution into the employee retirement plan, when the employer acts in the capacity of a loaning entity and loan the employee funds to be contributed into her/his retirement plan, may be vested. According to one unlimiting example, if the employer loan is a five-year loan it may be that 20% of it is forgiven with every employment year after the commencement of the loan.

As accumulation of funds for retirement is crucial, the IRS provides a significant capacity for investment in retirement plans. The limit for combined employee and employer contributions is either 100% of the employee salary or $61,000 (whichever amount is lower). Further, for employees who are fifty and older the limit goes up to $67,500. It is the intension of the presently disclosed methods and system to enable employees to contribute the maximum allowable toward their retirement. For example, it may be tax-wise advantageous for an employee to work with their employer to reduce their salary, thereby reducing their tax liability while contributing the maximum allowable to their retirement plans. This may enable companies to invest more toward employees' benefits, such as retirement plans and broad-based employee stock ownership plans.

This is also in accordance with the presently disclosed methods and systems which allow for circumstantial optimization of contribution to employee-provided benefit plans, such as retirement plans or broad-based employee stock ownership plans. For example, if an employee is approaching 59.5 (i.e., for some plans the age is for penalty-free withdrawals) they may want to allocate most of their salary to their retirement plan. As another example, the flexibility that the presently disclosed methods and systems offer enable an Employee to invest a a one-time payment (e.g., a bonus) in their retirement plan.

In fact, the presently disclosed methods and systems are designed to allow employees to optimize their overall employer-provided benefits within the constraints of the employees individual circumstances. This is important because different types of benefits have different caps (maximum allowable contributions), tax benefits (such as pre-tax contributions for retirement plans), and short/long-term considerations (e.g., ESPP involves relatively short-term considerations while management of a 401(k) plan long-term considerations). In some embodiments of the present disclosure, a third-party administrator helps the employer to optimize their budget with regards to employees benefits and salaries. In some embodiment, the employer provides the third-party administrator with a fee for the services rendered. In some other embodiments, the employer provides the third-party administrator an interest for any funds loaned. In some embodiments, the third-party administrator works with both employees and employer to achieve an optimal ratio of salary to benefits.

For instance, a company may budget $XX,XXX towards benefits or $XXX,XXX salary/benefit mix, the third-party administrator then gives the employee an opportunity to optimize and elect the optimal mix for him or her. In some other embodiments of the present disclosure, employees using a specific benefit are “pooled” in one shared loan. In the example of retirement plans, it enables flexibility for the return of the loan wherein payments from employees who are 59.5 years or older to contribute more toward the return of the loan then younger employees who may incur a tax penalty when receiving a distribution from their retirement plan. The third-party administrator manages the pooled employees loan returns to that short-term loans from Loaning entities are paid ahead of long term loans.

In a preferred embodiment, the loan offering can be a one-year renewable “note” having monthly loan payouts to enrolled employees who will be required to repay the 12-month loan or note early the following year. Employees can have a number of options available to them concerning loan repayment. In one embodiment, the repayment is a sale option available in most post-tax ESPP plans known to those of ordinary skill in the art. In this manner, employees can use this sale and withdrawal of their ESPP contributions made over the year to repay the loan (with any contingent interest/fees) in one lump sum. The employee simply repays his total ESPP contribution back to the loaning institution and retains the net employer-matched funds.

In any of the embodiments of the present disclosure, the value of the loan to the employee/borrower can be sold to a third party, either as options or whole. In any of the embodiments of the present disclosure, the system and method may comprise holding the employee/borrower payroll contributions in an escrow savings account. In any of the embodiments of the present disclosure, the loaning entity reimbursement transaction may be configured to occur on an ad hoc basis in the form of equity in the cooperative, cash, or a plurality of both. In any of the embodiments of the present disclosure, the loaning entity reimbursement may comprise contingent loan interest and/or other fees paid to secure the loan. However, in other embodiments of the presently disclosed systems and methods, the loaning entity reimbursement may comprise does not comprise loan interest.

In any of the embodiments of the present disclosure, the loaning entity reimbursement transaction may be configured to occur upon purchase of stock from escrow account per plan policy. In any of the embodiments of the present disclosure, the loaning entity reimbursement transaction may be settled through tax returns of the employee contributing into the employee stock purchase plan. In any of the embodiments of the present disclosure, the sum of the loaning entity reimbursement transaction may be greater than the sum of the employee originations in cases where options are sold, or the market price falls below the discounted price. In any of the embodiments of the present disclosure, the total amount of funds contributed by the employee is the minimum allowable at the beginning of the enrollment period and the maximum allowable at the end of enrollment period, strategized to receive the maximum benefit with the minimum period of the investment outstanding.

### EXAMPLE

With the above parameters in mind, the transaction dollar amounts for another hypothetical employee, ESPP for an employee's 401(k) contributions, and employer operating in accordance with the system and method of the present invention, provide the following results:
An the employee earns $48,000.00 per year.
The ESPP provides a 15% employer stock discount at (1% to 25% contribution up to $7,500) means a $7,500.00 employee contribution gaining an unrealized value of $1,275.00 subsidy
(total=employee contribution +employer subsidy =$8,775.00 per year). This excludes the value of options that can be created with the ESPP asset, and the possible appreciation and depreciation to the investment principal (i.e., the original $7,500);
Loaning entity loans back the employee $7,500 per year through loans contingent fee/interest loans originated at the discretion of the employee ($500+$1,000+$1,000+$1,000+$2,000+$1,000+$1,000=$7,500).
Based on the change of the stock price, accumulated loan origination, quantity of loan origination, and balance period outstanding, the employee pays a contingent fee/interest commission to gain the “free” matched money and have the financial institution take care of all the electronic transactions and interest payment on the loan to them. (Note: the contingent calculation could be changed determined at whatever the market can bear, for example 50/50 of any gains. Additionally, if the stock goes below the floor the loaning entity can pay accumulated interest or fees to the employee for their participation).
The total match by the employer is $1,275.00 per year. But the probable appreciation and floor provide value to issue options.
In summary, the employee pays $X per year in this example to have a ESPP account build to $1,275.00 per year each year, which can then earn more money as the stock appreciates or options are issued therein.

As is demonstrated by the description above and accompanying figures, the present invention fulfills the need for a system and method of extending financial assistance to employees with access to broad-based employee stock ownership plan discounting plans by employers. This method allows employees to secure the maximum number of discounted stock available to them without the increased financial burden associated with providing a maximum contribution.

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the chemical, mechanical, electromechanical, electrical, and computer arts will readily appreciate that the present invention may be implemented in a wide variety of embodiments. This application is intended to cover any adaptations or variations of the preferred embodiments discussed herein. Therefore, it is manifestly intended that this invention be limited only by the claims and the equivalents thereof.

It should be appreciated and understood that the present invention may be embodied as systems, methods, apparatus, computer readable media, non-transitory computer readable media and/or computer program products. The present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” The present invention may take the form of a computer program product embodied in one or more computer readable medium(s) having computer readable program code embodied thereon.

One or more computer readable medium(s) may be utilized, alone or in combination. The computer readable medium may be a computer readable storage medium or a computer readable signal medium. A suitable computer readable storage medium may be, for example, but not limited to, an electronic, magnetic, optical, electromagnetic, infrared, or semiconductor system, apparatus, or device, or any suitable combination of the foregoing. Other examples of suitable computer readable storage medium include, without limitation, the following: an electrical connection having one or more wires, a portable computer diskette, a hard disk, a random access memory (RAM), a read-only memory (ROM), an erasable programmable read only memory (EPROM or flash memory), an optical fiber, an optical storage device, a magnetic storage device, or any suitable combination of the foregoing. A suitable computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Python, C++ or the like and conventional procedural programming languages, such as the “C” programming language or similar programming languages. The program code may execute entirely on the user's computing device (such as, a computer), partly on the user's computing device, as a stand-alone software package, partly on the user's computing device and partly on a remote computing device or entirely on the remote computing device or server. In the latter scenario, the remote computing device may be connected to the user's computing device through any type of network, including a local area network (LAN) or a wide area network (WAN), or the connection may be made to an external computing device (for example, through the Internet using an Internet Service Provider).

The present invention is described herein with reference to flowchart illustrations and/or block diagrams, can be implemented by computer program instructions. These computer program instructions may be provided to a processor of a general purpose computing device (such as, a computer), special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computer program instructions may also be stored in a computer readable medium that can direct a computing device, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions/acts specified in the flowchart and/or block diagram block or blocks.

It should be appreciated that the function blocks or modules shown in the drawings illustrate the architecture, functionality, and operation of possible implementations of systems, methods and computer program media and/or products according to various embodiments of the present invention. In this regard, each block in the drawings may represent a module, segment, or portion of code, which comprises one or more executable instructions for implementing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order, depending upon the functionality involved.

It will also be noted that each block and combinations of blocks in any one of the drawings can be implemented by special purpose hardware-based systems that perform the specified functions or acts, or combinations of special purpose hardware and computer instructions. Also, although communication between function blocks or modules may be indicated in one direction on the drawings, such communication may also be in both directions.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claim is:

1. A method of electronically maximizing an employee's defined benefit plan contribution within an employer's defined benefit plan, comprising:
a. Providing a computerized system for use, maintenance and execution within said employer's defined benefit plan, said computerized system having
i. At least one central processing unit;
ii. Non-transitory memory operationally connected to said at least one central processing unit;
iii. One or more algorithms written into said non-transitory memory for operation of said at least one central processing unit;
b. Providing an employer provided defined benefit plan for employee use through said computerized system;
c. Providing an employer provided defined benefit plan account for employee use through said computerized system;
d. Using employer's electronic computerized system for management and use of said employer provided defined benefit plan and said employer provided defined benefit plan account;
e. Connecting an employee's contribution to said defined benefit account to said employer's computerized system;
f. Calculating the difference between said employee's contribution to said defined benefit account and the maximum allowed contribution to said defined benefit account by said algorithm;
g. Providing an electronic line of credit for additional stock purchase usable by said employee on an ad hoc basis to maximize said employee's defined benefit account, said electronic line of credit storable in an electronic ledger on said computerized system, said electronic ledger being accessible to said employee;
h. Purchasing a maximum number of discounted stock shares from proceeds from said line of credit; and
i. Electronically depositing said purchased discounted stock shares into said employee's defined benefit account.

2. The method of claim 1 wherein said electronic line of credit represents a total wherein said total is subject to contingent loan interest and other fees paid to secure said interest free loan.

3. The method of claim 1 wherein said electronic line of credit represents a total wherein said total is not subject to contingent loan interest.

4. The method of claim 1 wherein said electronic line of credit is a transaction configured to occur periodically.

5. The method of claim 1 further comprising creating a loan for the employee in order to provide for funds to return the loaned funds.

6. The method of claim 1 wherein said employee makes contributions to their retirement plan according to their financial ability and allows said loaning entity contribute the remaining funds up to a maximum allowable amount.

7. The method of claim 1 wherein said employee withdraws funds from his retirement plan to enable return of the loaned funds.

8. The method of claim 1 wherein said electronic line of credit provided by the employer is vested and a certain percentage of the loan is forgiven with each year of employment after the commencement of the loan.

9. The method of claim 1 wherein the employee uses a retirement plan payback loan to return money used from said electronic line of credit.

10. The method of claim 9 wherein the retirement plan payback loan is a deferred loan.

11. The method of claim 1 wherein said electronic ledger comprises an attached debit card for said employee's use.
